(19) United States
(12) Patent Application Publication
(10) Pub. No.: US 2007/0042815 A1
(43) Pub. Date: Feb. 22, 2007

(54) Availability settings in mobile terminals

(76) Inventor: Flemming Trap, Copenhagen (DK)

Correspondence Address: PERMAN & GREEN, 425 POST ROAD, FAIRFIELD, CT, 06824, US

(21) Appl. No.: 10/537,689

(22) PCT Filed: Dec. 20, 2002
(86) PCT No.: PCT/EP02/14646

§ 371 Date: Sep. 20, 2006

(51) Int. Cl. H04M 1/00

(52) U.S. Cl. 455/575.1

(57) ABSTRACT

A mobile telephone has running as a background task thereon an instant messaging (IM) program. The IM program associates an availability setting of the mobile telephone, which setting is dependent on the profile to which the telephone is currently set. If an application is run or an activity commenced, this is detected at step (31) and the availability setting associated with that application or activity is detected at step (32). If the availability setting associated with the application or activity is higher in any way, for instance, because the setting indicates offline rather than online or unable to receive communications as opposed to able to receive communications, this is detected at step (33). If the setting is higher, the network is informed of the new setting as step (34). Once a detection that the activity or application has ended is made at step (36), the availability settings are reset at step (38), and the network informed of any revised setting at step (39). The disclosed mobile communications terminal avoids a user having to adjust manually the availability settings. The availability setting associated with each application, activity and profile is individually user definable.

### FIELD OF THE INVENTION

This invention relates to a mobile communications terminal having an adjustable availability setting. This invention relates also to a method of setting an availability setting.

### BACKGROUND OF THE INVENTION

Instant messaging (IM) is now well established on networked computers. When a user is logged onto a computer network, a presence setting associated with the user is set to ‘available’. In this case, all other users connected to the network and which have the user in their friends list can see that the user is available, and are able to send on IM to him or her. Instant messaging is also proposed for use with mobile telecommunications devices, notably mobile telephones and personal digital assistants (PDAs), see for example www.wireless-village.com. However, people's use of mobile telephones and PDAs is quite different to people's use of fixed networked workstations, and thus different considerations are required when designing an IM system for use with mobile telecommunication devices.

### SUMMARY OF THE INVENTION

According to a first aspect of the invention, there is provided a mobile communications terminal, comprising: means responsive to the commencement of an activity or the running of an application for adjusting an availability setting, and means for reporting the adjusted availability setting to or via a network.

This invention provides a particularly convenient manner in which the availability setting of a terminal can be changed without necessarily involving a user.

Preferably the adjusting means is arranged to adjust the availability setting depending on the identity of the application or the activity, in which case the availability setting associated with at least one application or activity may be user definable. The adjusting means preferably is arranged to adjust the availability setting depending on a selected operating profile of the terminal, in which case the availability setting associated with at least one operating profile may be user definable. These features contribute to the convenience which the invention provides.

The adjusting means is preferably arranged to adjust the availability setting to the highest one of a setting associated with the run application or the commenced activity and a setting associated with the selected operating profile. This allows the terminal to determine the best setting for the circumstances in a particularly straight-forward manner which does not require much processing resources.

As a preferred feature, the adjusting means is responsive to the ending of the activity or the ceasing of the running of the application to restore the availability setting to its previous setting. As such, any change in availability setting resulting from the running of an application or the participation in an activity is not permanent, and the setting is automatically readjusted appropriately.

The terminal may comprise means for allowing a user to define a different availability setting for a predetermined network user or a group of network users to a setting associated with other users. This allows a user to prioritise one or more network users over other users. This can be a particularly convenient feature if, for example, disturbance will be accepted only by one of a small number of people.

The terminal may comprise means for queuing one or more communications received in contravention of an availability setting without revealing the one or more communications to the user. This allows communications to be made even when the availability settings would not allow it, although without interrupting the user of the terminal when an indication has been made (by way of the availability setting) that interruption is not wanted.

The terminal preferably comprises means responsive to the receipt of a communication in contravention of an availability setting for automatically sending a reply communication, for convenience.

According to a second aspect of the invention, there is provided a method of setting an availability setting relating to a mobile communications terminal, the method comprising: detecting the commencement of an activity or the running of an application; and in response to a detection: adjusting an availability setting; and reporting the adjusted availability setting to or via a network.

Embodiments of the present invention will now be described, by way of example only, with reference to the accompanying drawings.

### BRIEF DESCRIPTION OF THE DRAWINGS

In the drawings:

FIG. 1 is a schematic diagram of a mobile communications terminal, in the form of a mobile telephone, according to one aspect of the invention and operating according to the other aspect of the invention; and

FIG. 2 is a flow diagram illustrating operation of the mobile telephone of FIG. 1.

### DETAILED DESCRIPTION OF THE PREFERRED EMBODIMENTS

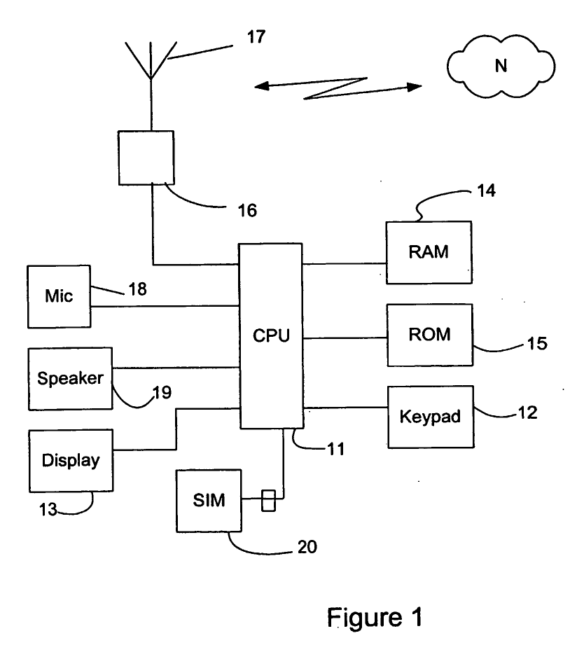

Referring to FIG. 1, a mobile telephone 10 is shown comprising generally a central processing unit (CPU) 11, which is connected to each of a keypad 12, a display 13, a random access memory (RAM) 14, a read only memory (ROM) 15 and a transceiver 16, which is also connected to an antenna 17. Also connected to the CPU 11 are a microphone 18, a speaker 19 and a subscriber identity module (SIM) card 20. The SIM card 20 is connected to the CPU 11 by a suitable connector, i.e. the SIM card is removable from the mobile telephone 10. The computer program which the CPU 11 runs in order to effect control of the mobile telephone 10 is stored in the ROM 15. The RAM 14 is used by the CPU 11 as a temporary storage area, for the storage of data and flags which are transient. The ROM 15 includes computer programs enabling the mobile telephone 10 to communicate with a network (not shown) via the transceiver 16 and the antenna 17, and also to provide other useful features, such as SMS messaging, email, games, calculator, alarms etc. The mobile telephone thusfar described is conventional.

The ROM 15 is also provided with a program which, when run by the CPU 11, effects an instant messaging (M) function. When the mobile telephone 10 is in an on-line state with the network, the IM program runs as a background task on the CPU 11. The IM program causes the CPU 11 to inform the network N of the presence setting associated with the telephone 10. The present setting includes the device capabilities of the mobile telephone. These capabilities include such information as whether or not the mobile telephone 10 can send and receive multimedia messages (MMS), emails, SMS messages, VoIP and session initiation protocol communications, for example. The network N also stores in respect of the mobile telephone 10 a reachability aspect of the present setting, which identifies whether or not the mobile telephone 10 is in connection with the network N [correct?]. An availability setting also forms part of the present setting. The availability setting is determined by the mobile telephone 10, in the manner described below.

The availability setting, which is determined by the mobile telephone 10 and held at the network N, determines the extent to which the mobile telephone is communicable with other devices connected to the network N. The availability setting includes a setting as to whether the mobile telephone 10 is ‘on-’ or ‘off line’, and whether or not it is able to receive communications. If the availability setting is “available” the mobile telephone is ‘online’ and is ‘able to receive communications’. If the availability setting is “away”, “do not disturb”, or “meeting”, then the mobile telephone 10 is ‘off line’ and is ‘unable to receive communications’. If the availability setting is “invisible”, the mobile telephone 10 is ‘offline’, but is ‘able to receive communications’. A “custom” availability setting allows a user of the mobile telephone 10 to set any desired combination of on and off line and able or not able to receive communications.

The availability settings are user definable through a menu system. A different availability setting is able to be set in respect of each operating profile which the mobile telephone 10 can be set too. For example, a user may want the availability setting associated with the “general” profile to be “available”. Similarly, a user may want to set the availability setting associated with a “silent” profile to be “invisible”.

The IM program stored in the ROM 15 is arranged to provide a default availability setting for each profile, so that an availability setting is available for each profile even if a user has not defined one manually.

A user may also, through a menu system, set an availability setting in respect of each activity and application which the mobile telephone 10 is programmed to use. For example, a user may be able to set an availability setting for each of the following applications (an application here being a computer program stored in the ROM 15 and able to be run on the CPU 11): an MMS or SMS composer or reader application, a game, a radio application, a WAP browser, a calculator and a stopwatch. A different availability setting can also be set for each of the following activities which can be carried out on the mobile telephone 10: voice call, emergency call, data call, menu navigation and voice memo recording. For example, a user may wish to set a “do not disturb” availability setting for emergency calls, voice memo recording, WAP browsing and game activities in applications, but set an “invisible” availability setting for radio and stopwatch applications and data call activities. Again, the IM program contains default settings for each of the activities and applications so that an availability setting is present even if the user has not programmed one in to the telephone 10.

Even when not being quoted, the mobile telephone 10 has certain programs being run as background tasks on the CPU 11. These programs will include a program for maintaining connection with the network N, and the IM program for instance. In this situation, the mobile telephone 10, particularly the CPU 11 thereof, is arranged to set an availability setting to equal the availability setting associated with the profile that is currently active on the telephone.

The CPU 11 is responsive to the running of an application, such as one of the applications mentioned above, to run a part of the IM program which determines the availability setting of the telephone. When application is run, the availability setting associated with that application (either the default setting or a user defined setting) is determined, and this is compared to the availability setting associated with the profile in which the telephone is currently operating. If the availability setting associated with the application is in any way higher than the setting associated with the profile, then the availability setting is adjusted. In this connection, ‘offline’ is treated as higher than ‘online’, and ‘not able to receive communications’ is treated as higher than ‘able to receive communications’. An availability setting can be considered to be higher if it is more restrictive as to the availability of the mobile telephone 10 to communications from users connected to the network N. Similarly, if an activity is commenced, the availability setting associated with that activity is detected, and a comparison is made with the profile in which the telephone 10 is currently operating. If the availability setting associated with the activity is in any way higher than the availability setting for the profile, the profile is adjusted accordingly. If one component of the availability setting for an application or activity is higher than that for the profile and the other component is lower than that for the profile, then the highest of each component is taken to be the setting

The availability setting is then reported to the network N by way of the transmission of suitable data on a control channel forming part of the link between the mobile telephone 10 and the network N. However, the transmission of the availability setting information can be communicated to the network N in any other convenient manner. Preferably, though, the mobile telephone 10 is arranged to continue transmitting periodically the availability setting information until proper receipt of it has been confirmed by way of suitable transmission from the network N or until the setting is changed again.

To reduce the amount of traffic communicated between the mobile telephone 10 and the network N, it may be desirable to cause the availability setting to be transmitted only if it has changed, that is to say that if the running of the application or the commencement of the activity does not result in a higher availability setting (for either component), then no availability setting would be communicated to the network N.

The CPU 11 is arranged to detect when the activity has ended or the application has stopped running, as the case may be. Once a detection has been made, the availability setting of the mobile telephone 10 is reverted to the setting which was present before the application was run or the activity started, as the case may be.

The network N is thus continually aware of the availability setting associated with the mobile telephone 10. This availability setting is communicated to all those users connected to the network N who are on a “friends list” of the user of the mobile telephone. The availability setting of the mobile telephone 10 may be communicated to these other users in any suitable way. As an example, a green icon may be displayed if the mobile telephone is online and able to receive communications, an orange icon displayed if the telephone is online but unable to receive communications, and a red icon may appear if the telephone is offline. If a person sends an instant message to the mobile telephone 10, the network N examines the availability setting associated with the telephone and takes appropriate action. If the mobile telephone 10 has an availability setting which indicates that communications are not to be received, the network N stores the instant message for delivery to the mobile telephone 10 once the availability setting is changed such that communications can be received. If, instead, the availability setting indicates that the mobile telephone 10 is able to received messages, the instant message is transmitted immediately to the telephone. If the mobile telephone 10 has an availability setting of offline, the instant message is stored at the network N until the availability setting is changed such that it is online and is able to receive communications.

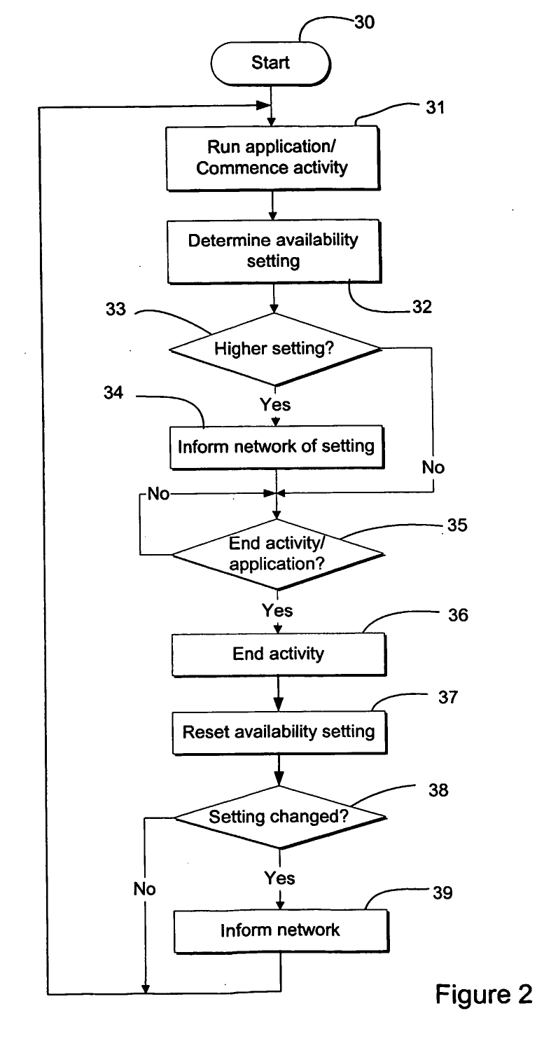

The operation of the mobile telephone and the setting of its availability setting is now described with reference to FIG. 2. Operation begins at step 30, although it will be appreciated that the IM program normally is continually run by the CPU as a background task. When an application is run or an activity is commenced, this is detected at step 31. Following this detection, the availability setting associated with the application or activity is determined at step 32. At step 33 it is determined whether or not the availability setting associated with the application or activity is in any way higher than the availability setting associated with the current operating profile of the mobile telephone 10. If the setting is higher, then the network is informed of the revised setting at step 34. Following step 34, or if the setting is determined by step 33 not to be higher, a determination is made at step 35 as to whether the application has stopped being run or whether the activity has ended. If a negative determination is made, operation proceeds again to step 35, thereby controlling the program to remain in a loop until the application has stopped running or the activity has ended, when progression is made to step 36. Following step 36, the availability setting associated with the mobile telephone 10 is set to the setting which was present before the application was run or the activity was commenced. At step 38, it is determined whether or not this setting is lower than the setting which is stored at the network N. If a positive determination is made, the network N is informed of the new availability setting as step 39. Following step 39 or a negative determination from step 38, the operation proceeds again to start at step 30.

The IM program includes instructions for enabling the CPU 11 to allow a user to define one or more groups of friends to who special availability settings are to be made available. Following the creation of a group, a user is able to associate with that group different availability settings for each of the profiles in which the mobile telephone 10 can operate and in respect of each of the applications or activities which can be operated. This allows a user to set, for example, lower availability settings in respect of some or all applications or activities or profiles in respect of certain users, for example a spouse and a parent. However, since the mobile telephone 10 can then have a different availability settings for a given application, activity or profile for different users of the network N, it is necessary to store the identities of the other users (telephone numbers, for example) and the availability settings associated with those users at a given time at the network N. As a result, the network N can make different availability setting for the mobile telephone 10 available to different users of the network, and handle communications directed at the telephone differently depending on the originator.

The mobile telephone 10 is preferably arranged such that a user thereof can select or generate a reply message, which is then stored at the network N. When the network N receives a communication addressed to the mobile telephone 10 but the availability setting (taking into account whether or not the originator is a member of a special group) indicates that the telephone is unable to receive messages, the network sends the reply message to the originator of the communication. The reply message might indicate, for example, that the user is unable to receive communications at present.

Although the above described mobile communication terminal is a mobile telephone, the invention is not so limited. Instead, the terminal could be, for example, a personal digital assistant (PDA), a pocket personal computer connectable to a network via a wireless connection, or any other similar device. Also, although the availability setting has been described in relation to the availability of the user of the mobile telephone to receive instant messages in an IM system, the availability setting may be used by the network N to determine whether or not other kinds of messages or communications are receivable. Such may be SMS or MMS messages, voice calls or emails for example. The scope of the invention is intended to be limited only by the appended claims.

In an alternative embodiment, the availability setting for a user is not stored at the network N. Instead, the network N maintains an on- or off-line status of each terminal, and it is the responsibility of each terminal to determine from the network the status of each of the users on the friendslist associated with that terminal. When there is a change in the availability setting associated with a terminal, the terminal then reports the revised setting, or the change in the setting, via the network N, to each of the users on the friendslist which have an on-line status. In this embodiment, the network does not need to be aware of the identities of the users in the group or groups with which different availability settings are associated, since the terminal itself is responsible for making available the availability settings to the users on the friendslist.

1. A mobile communications terminal, comprising:
Means responsive to the commencement of an activity or the running of an application for adjusting an availability setting, and
Means for reporting the adjusted availability setting to or via a network.

2. A terminal as claimed in claim 1, in which the adjusting means is arranged to adjust the availability setting depending on the identity of the application or the activity.

3. A terminal as claimed in claim 2, in which the availability setting associated with at least one application or activity is user definable.

4. A terminal as claimed in claim 1, wherein the adjusting means is arranged to adjust the availability setting depending on a selected operating profile of the terminal.

5. A terminal as claimed in claimed 4, in which the availability setting associated with at least one operating profile is user definable.

6. A terminal as claimed in claim 2, in which the adjusting means is arranged to adjust the availability setting to the highest one of a setting associated with the run application or the commenced activity and a setting associated with the selected operating profile.

7. A terminal as claimed in claim 1, in which the adjusting means is responsive to the ending of the activity or the ceasing of the running of the application to restore the availability setting to its previous setting.

8. A terminal as claimed in claim 1, comprising means for allowing a user to define a different availability setting for a predetermined network user or a group of network users to a setting associated with other users.

9. A terminal as claimed in claim 1, comprising means for queuing one or more communications received in contravention of an availability setting without revealing the one or more communications to the user.

10. A terminal as claimed in claim 1, comprising means responsive to the receipt of a communication in contravention of an availability setting for automatically sending a reply communication.

11. A method of setting an availability setting relating to a mobile communications terminal, the method comprising:
detecting the commencement of an activity or the running of an application; and
in response to a detection:
adjusting an availability setting; and
reporting the adjusted availability setting to or via a network.

12. Method as claimed in claim 11, in which the adjusting step includes adjusting the availability setting depending on the identity of the application or the activity.

13. A method as claimed in claim 12, in which the availability setting associated with at least one application or activity is user definable.

14. A method as claimed in claim 11, in which the adjusting step includes adjusting the availability setting depending on a selected operating profile of the terminal.

15. A method as claimed in claim 14, in which the availability setting associated with at least operating profile is user definable.

16. A method as claimed in claim 12, in which the adjusting step comprises adjusting the availability setting to the highest one of a setting associated with the one application or the commenced activity and a setting associated with the selected operating profile.

17. A method as claimed in claim 11, comprising detecting the ending of the activity or the ceasing of the running of the application, and in response to a detection restoring the availability setting to its previous setting.

18. A method as claimed in claim 11, comprising allowing a user to define a different availability setting for a predetermined network user or a group of network users to a setting associated with other users.

19. A method claimed in claim 11, comprising queuing one or more communications received in contravention of an availability setting without revealing the one or more communications to the user.

20. A method as claimed in claim 11, comprising automatically sending in response to the receipt of a communication in contravention of an availability setting a reply communication.
